(19) United States
(12) Patent Application Publication
(10) Pub. No.: US 2018/0056712 A1
(43) Pub. Date: Mar. 1, 2018

(54) Die Cut Tool

(71) Applicant: Wanaree Tanner, Camden, IL (US)

(72) Inventor: Wanaree Tanner, Camden, IL (US)

(21) Appl. No.: 15/693,196

(22) Filed: Aug. 31, 2017

Related U.S. Application Data
(60) Provisional application No. 62/381,697, filed on Aug. 31, 2016.

(51) Int. Cl. B44C 3/08; B44C 1/24; B44B 11/04

(52) U.S. Cl. CPC B44C 3/082; B44B 2700/12; B44B 11/04; B44C 1/24

(57) ABSTRACT

A die cut tool for applying high or low relief dimensional elements onto a malleable media includes an interchangeable tool head, a magnetic fastening mechanism, and a tool handle. The magnetic fastening mechanism selectively couples the interchangeable tool head to the tool handle. The interchangeable tool head includes an outer cutting blade and a sculpting face. The sculpting face, when pressed against the malleable media, creates high or low relief dimensional elements. The outer cutting blade separates the dimensional element from the surrounding malleable media. The tool handle includes a socket portion and a gripping portion. The interchangeable tool head is securely retained inside the socket portion. The gripping portion provides a gripping surface whereby a user can securely grip the tool handle.

The current application claims a priority to the U.S. Provisional Patent application Ser. No. 62/381,697 filed on Aug. 31, 2016.

### FIELD OF THE INVENTION

The present invention generally relates to a die cut tool. More specifically, a die cut tool for making high or low relief dimensional elements on a malleable media includes an interchangeable tool head and a tool handle.

### BACKGROUND OF THE INVENTION

Conventional die cut tools are pressed against a malleable media to create high or low dimensional relief elements. The malleable media is a soft pliable material, such as clay, that can easily be molded into the desired shape. As such, the tool head presses down on the malleable media and molds the malleable media into the desired shape. In most cases, the malleable media is shaped into ornamental sculpture that can be used to decorate an object. Once the dimensional element is sculpted to the desired shape, it is separated from the rest of the malleable media. The dimensional element may then be hardened by applying heat to it or leaving it out to dry.

The die cut tools also include sculpting faces that are fashioned with negative or positive molds that, when pressed against the malleable media, create high or low dimensional elements. A non-stick coating is usually applied on top of the malleable media to prevent it from getting stuck onto the sculpting face. However, in certain cases, the pressure of the sculpting face pressing against the malleable media can cause the malleable media to get stuck inside the sculpting face. Trying to dislodge the malleable media from the sculpting face without distorting or damaging the dimensional elements can be very difficult.

The present invention is a die cut tool with a tool handle and interchangeable tool heads for sculpting dimensional elements on a malleable media. A novel magnetic fastening mechanism allows the user to press on the distal portions of the tool head, thereby reducing the pressure of the sculpting face pressing against the malleable media. This prevents the malleable media from getting stuck inside the sculpting face. As such, the present invention allows of undistorted dimensional elements.

### BRIEF DESCRIPTION OF THE DRAWINGS

FIG. 1 is a top perspective view of the present invention in the upside-down position.

FIG. 2 is a top perspective view of the present invention in right-side up position.

FIG. 3 is a perspective exploded view of the present invention showing the interchangeable tool head, the magnetic fastening mechanism, and the tool handle.

FIG. 4 is a top view of the present invention.

FIG. 5 is a cross section view of the present invention taken about line 4-4 that shows the position of the magnetic fastening mechanism inside the interchangeable tool head and the tool handle.

FIG. 6 is a top perspective exploded view of the tool head showing the first magnet and the protruding shaft.

FIG. 7 is a top perspective view of the tool head showing the first magnet configured inside the protruding shaft.

FIG. 8 is a bottom perspective exploded view of the handle showing the second magnet and the socket portion.

FIG. 9 is a cross section view of the present invention taken about line 8-8 that shows the tool handle sliding about the interchangeable tool head.

FIG. 10 is a bottom perspective view of the interchangeable tool head showing the sculpting face and the outer cutting blade.

### DETAILED DESCRIPTION OF THE INVENTION

All illustrations of the drawings are for the purpose of describing selected versions of the present invention and are not intended to limit the scope of the present invention.

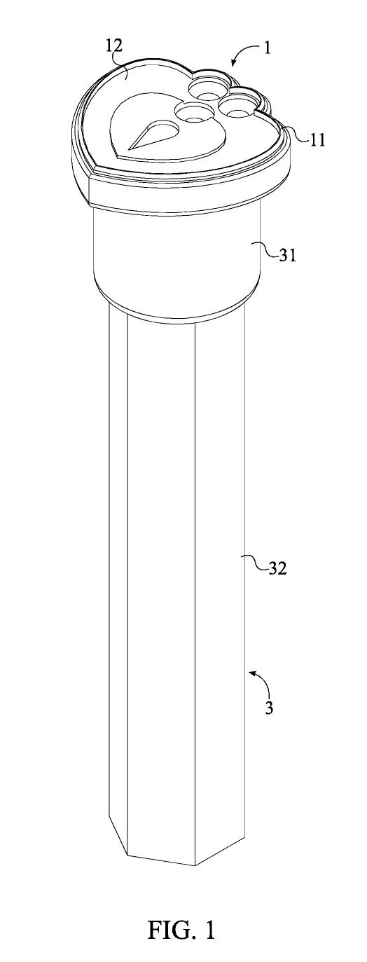

The present invention is a die cut tool for applying high or low relief dimensional elements on a malleable media that prevents the malleable media from getting wedged into the die cut tool. FIG. 1 shows the present invention in the operative configuration with interchangeable tool head 1 in the face-up position. The preferred embodiment of the present invention comprises an interchangeable tool head 1, a magnetic fastening mechanism 2, and a tool handle 3. The interchangeable tool head 1, when pressed against the malleable media, creates high or low dimensional elements on the malleable media. As such, the interchangeable tool head 1 can have various ornamental designs for sculpting dimensional elements of different shapes. The interchangeable tool head 1 comprises an outer cutting blade 11 and a sculpting face 12. As pressure is exerted onto the interchangeable tool head 1, the sculpting face 12 sculpts dimensional elements on the malleable media while the outer blade cleanly cuts the surrounding malleable material. The magnetic fastening mechanism 2 is distributed between the interchangeable tool head 1 and the tool handle 3. As such, the magnetic fastening mechanism 2 selectively couples the interchangeable tool head 1 to the tool handle 3. The tool handle 3 allows a user to manipulate the interchangeable tool head 1. In particular, the tool handle 3 is used to press the interchangeable tool head 1 against a malleable media, thereby creating a high or low relief element on the malleable media. The preferred malleable media is a pliable material, such as clay. The malleable material may harden when heat is applied, thereby preserving the dimensional element created by the present invention.

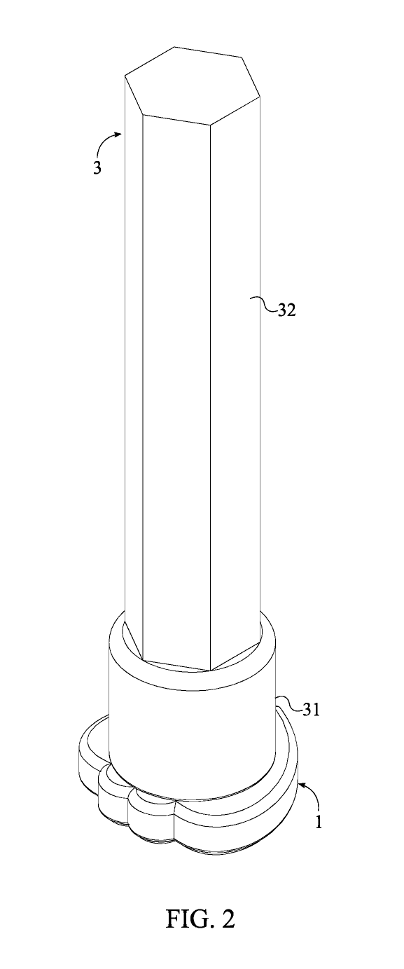

FIG. 2 shows the present invention with the interchangeable tool head 1 in the face-down position. The tool handle 3 comprises a socket portion 31 and a gripping portion 32. In the preferred embodiment of the present invention, the socket portion 31 is connected adjacent to the gripping portion 32. As such, the socket portion 31 terminally mounts to the tool handle 3. The gripping portion 32 provides a secure gripping surface, whereby the user can apply pressure on the interchangeable tool head 1 without the fear of slipping and losing grip.

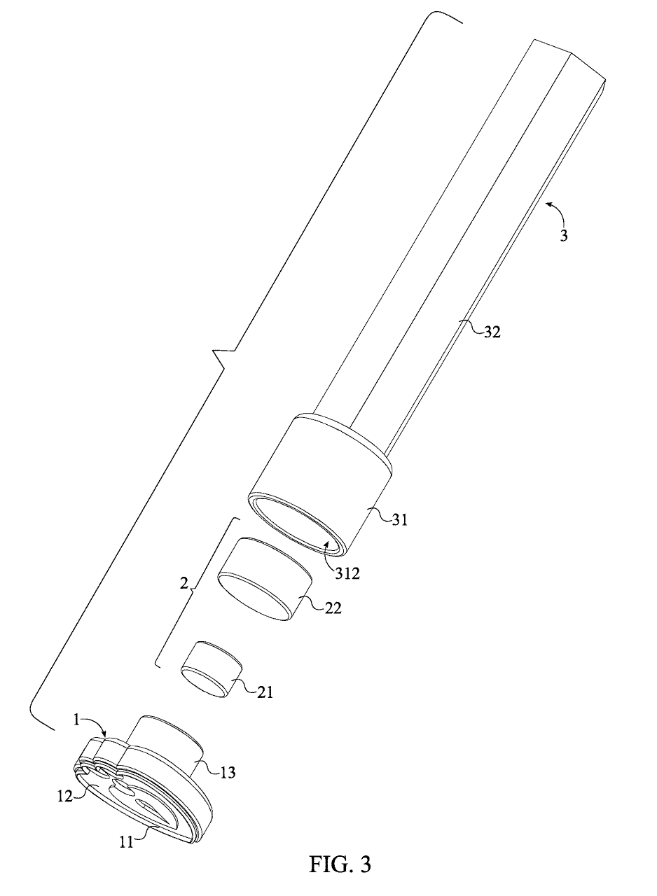

Referring now to FIG. 3, an opening 312 of the socket portion 31 is oriented away from the gripping portion 32. The interchangeable tool head 1 is releasably and slidably attached into the socket portion 31 by the magnetic fastening mechanism 2. More specifically, the magnetic fastening mechanism fastens the interchangeable tool head 1 to the tool handle 3 in a frictionless manner, which allows the interchangeable tool head 1 to move inside the socket portion 31. Once mounted inside the socket portion 31, the sculpting face 12 is oriented away from the magnetic fastening mechanism 2. This positions the sculpting face 12 directly on top of the malleable media when the user grips onto the gripping portion 32. The outer cutting blade 11 is perimetrically positioned around the sculpting face 12. The outer cutting blade 11 cleanly separates the dimensional element from the rest of the malleable media. The dimensional element is a high or low relief sculpture molded out of the malleable media by the sculpting face 12. Application of heat to the dimensional elements hardens the malleable media and preserves the ornamental designs of the dimensional elements.

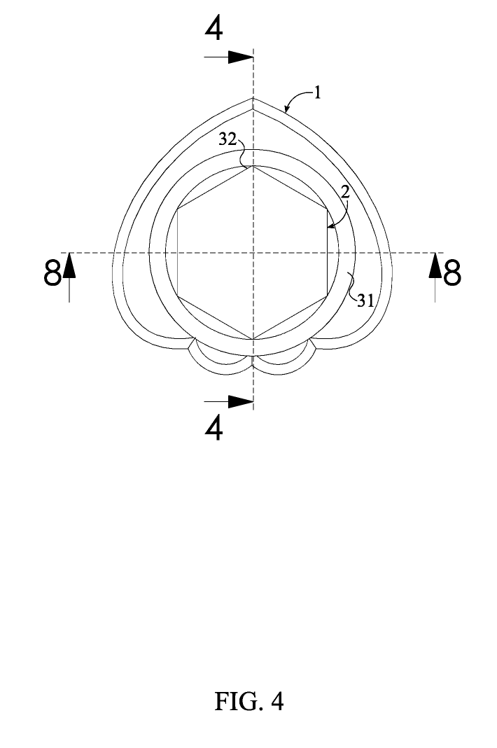

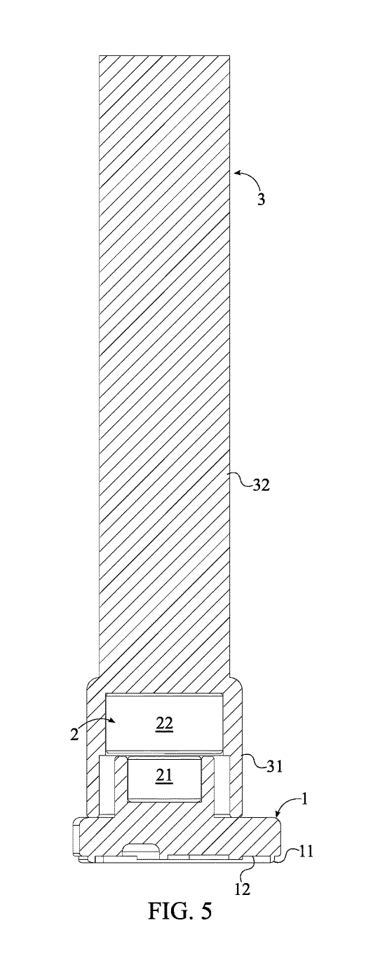

Referring now to FIG. 4 and FIG. 5, the magnetic fastening mechanism 2 comprises a first magnet 21 and a second magnet 22. The first magnet 21 is mounted onto the interchangeable tool head 1, opposite the sculpting face 12. The first magnet 21 allows the interchangeable tool head 1 to engage the socket portion 31 of the tool handle 3. Likewise, the second magnet 22 is integrated into the socket portion 31. When the interchangeable tool head 1 is inserted into the socket portion 31, the first magnet 21 and the second magnet 22 are placed in close proximity to each other. As a result, the first magnet 21 and the second magnet 22 are magnetically coupled to each other. The magnetic attraction between the first magnet 21 and the second magnet 22 is strong enough to prevent the interchangeable tool head 1 from separating from the socket portion 31 and thus the tool handle 3. However, the magnetic attraction is weak enough to allow the user to physically separate the interchangeable tool head 1 from the tool handle 3, if desired by the user.

In the preferred embodiment of the present invention, the first magnet 21 is configured onto the interchangeable tool head 1 to magnetically attract the second magnet 22. Likewise, the second magnet 22 is configured into the socket portion 31 to magnetically attract the first magnet 21. More specifically, the first magnet 21 is positioned with the north pole facing out of the interchangeable tool head 1. The second magnet 22 is positioned with the south pole facing out of the socket portion 31. In an alternate embodiment, the south pole of the first magnet 21 may be facing out of the interchangeable tool head 1, and the north pole of the second magnet 22 may be facing out of the socket portion 31.

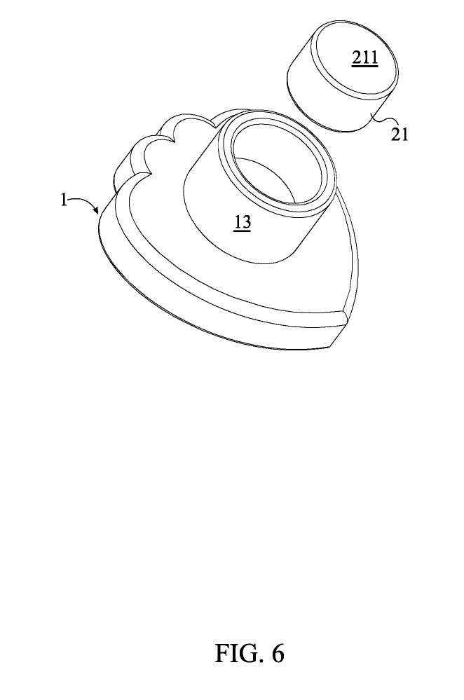

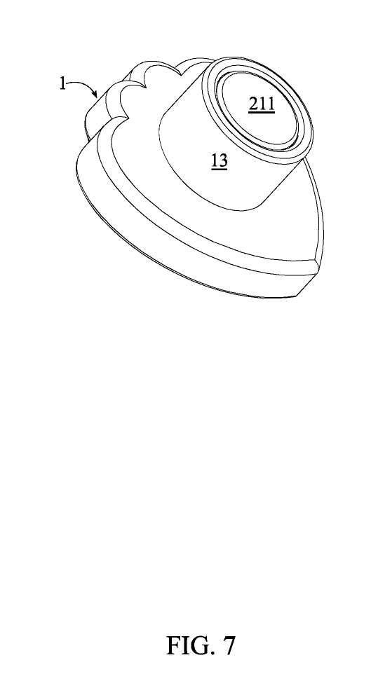

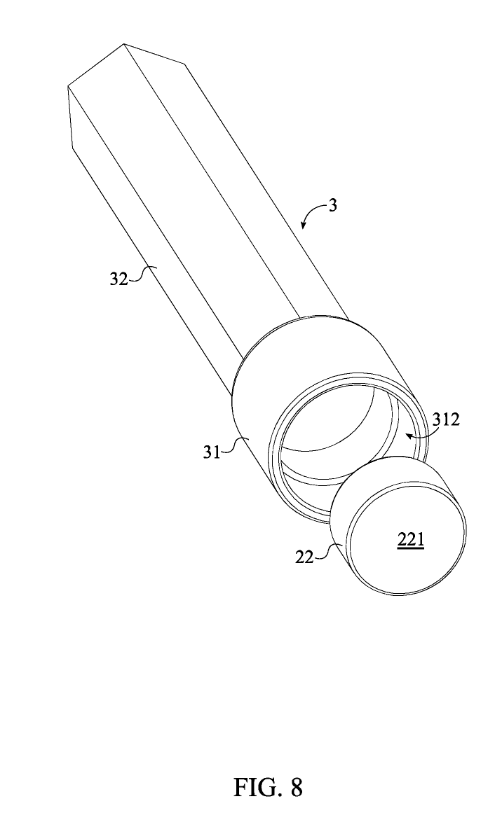

Referring now to FIG. 6, FIG. 7, and FIG. 8, the first magnet 21 comprises a first interface area 211. Further, the second magnet 22 comprises a second interface area 221. The first interface area 211 is exposed out of the interchangeable tool head 1, and the second interface area 221 is exposed out of the socket portion 31. In the preferred implementation of the present invention, when the interchangeable tool head 1 is inserted into the socket portion 31, the first interface area 211 is vertically offset from the second interface area 221. Even though the first interface area 211 and the second interface area 221 are offset from each other, the magnetic attraction between the first magnet 21 and the second magnet 22 securely fastens the interchangeable tool head 1 to the tool handle 3. The first interface area 211 is also smaller than the second interface area 221. Since the first interface area 211 is smaller in diameter than the second interface area 221, the first magnet 21 is physically smaller than the second magnet 22. As such, the first interface area 211 can slide about the second interface area 221. This allows the user to slidably move the tool handle 3 about the interchangeable tool head 1, thereby exerting pressure directly on top of the outer cutting blade 11. Alternately, the first interface area 211 may also be positioned coincident to the second interface area 221.

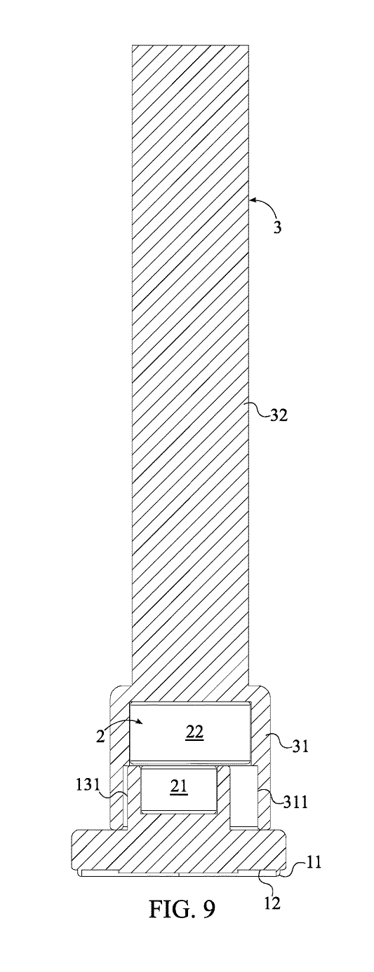

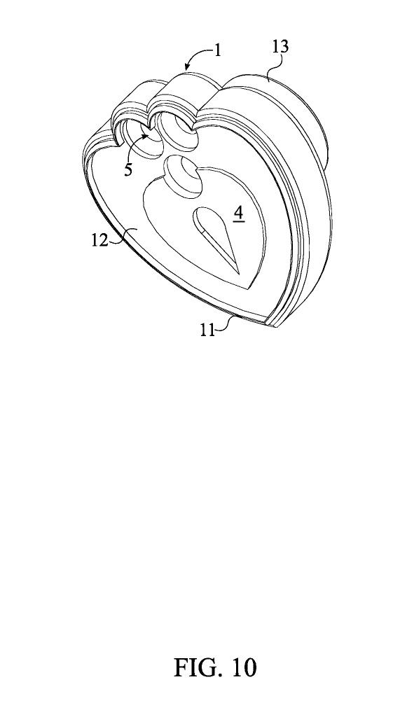

Referring back to FIG. 9 and FIG. 10, the present invention comprises at least one stamping protrusion 4. The at least one stamping protrusion 4 can be used to imprint a low relief dimensional element on the malleable media. As such, the at least one stamping protrusion 4 is connected onto the sculpting face 12. More specifically, the at least one stamping protrusion 4 is projected outwards from the sculpting face 12. When the interchangeable tool head 1 is pressed on top of the malleable media, the at least one stamping protrusion 4 presses down onto the malleable media, thereby creating a low relief element.

Further, the interchangeable tool head 1 comprises at least one stamping recess 5. The at least one stamping recess 5 can be used to imprint a high relief dimensional element on the malleable media. As such, the at least one stamping protrusion 4 is connected onto the sculpting face 12. When the interchangeable tool head 1 is pressed on top of the malleable media, the at least one stamping recess 5 creates a protruding dimensional element that raises out of the surrounding malleable media. Additionally, the magnetic fastening mechanism 2 allows the user to change the ornamental design of the at least one stamping recess 5 and the at least one stamping protrusion 4 by replacing the interchangeable tool head 1.

Referring now to FIG. 7, the interchangeable tool head 1 further comprises a protruding shaft 13. The protruding shaft 13 protrudes out of the rear surface of the interchangeable tool head 1, opposite the sculpting face 12. The first magnet 21 is inserted inside a first circular slot drilled into the protruding shaft 13 of the interchangeable tool head 1. A variety of fastening mechanisms may be used to affix the first magnet 21 to the protruding shaft 13. For example, the first magnet 21 may be glued to the protruding shaft 13. Alternately, the first magnet 21 may screw, interlock, or mechanically bond to the first circular slot.

Referring to FIG. 8, the second magnet 22 from the magnetic fastening mechanism 2 is inserted into a second circular slot positioned inside of the socket portion 31. More specifically, the preferred second circular slot is a hole drilled into the base surface of the socket portion 31. Like the first magnet 21, the second magnet 22 may be glued to the second circular slot. This creates a strong mechanical bond between the socket portion 31 and the second magnet 22. Alternately, the second magnet 22 may be fitted to the socket portion 31 in a manner that prevents the second magnet 22 from being dislodged from the socket portion 31.

Referring back to FIG. 7 and FIG. 8, to connect the interchangeable tool head 1 to the tool handle 3, the protruding shaft 13 traverses into the opening 312 of the socket portion 31. When the protruding shaft 13 is inserted into the socket portion 31, the first magnet 21 is positioned coincident to the second magnet 22. The magnetic attraction between the first magnet 21 and the second magnet 22 is used to selectively couple the protruding shaft 13 to the socket portion 31. As implemented, the magnetic attraction is greatest in the longitudinal direction along the length of the tool handle 3. This prevents the protruding shaft 13 from being separated from the socket portion 31. In contrast, the magnetic attraction in the horizontal direction is relatively weak. This allows the first interface area 211 to shift about the second interface area 221. Additionally, the first interface area 211 can be used as a fulcrum to physically slide the tool handle 3 about the interchangeable tool head 1. As such, the protruding shaft 13 is slidably mounted within the socket portion 31.

Referring specifically to FIG. 8 and FIG. 9, an outer lateral surface 131 of the protruding shaft 13 is encircled by an inner lateral surface 311 of the socket portion 31. This allows the tool handle 3 to slide about the interchangeable tool head 1. More specifically, the outer lateral surface 131 of the protruding shaft 13 slides closer to the inner lateral surface 311 of the socket portion 31. The inner lateral surface 311 of the socket is annularly offset from the outer lateral surface 131 of the protruding shaft 13. This allows the user to apply pressure directly on the distal portions of the interchangeable tool head 1.

Before the sculpting face 12 is pressed against the malleable media, a non-stick coating is applied on the malleable media. Although the coating reduces the likelihood of the malleable media from adhering to the sculpting face 12, application of excessive pressure can reduce the effectiveness of the coating. As such, it is necessary to reduce the pressure being exerted on the sculpting face 12. This is achieved by sliding the tool handle 3 about the interchangeable tool head 1. For example, sliding the tool handle 3 to the left of the interchangeable tool head 1 increases the pressure acting on the left side of the outer cutting blade 11. Accordingly, this reduces the pressure of the sculpting face 12 against the malleable media, which prevents the malleable media from being wedged into the sculpting face 12. As the first interface area 211 is offset from the second interface area 221, the tool handle 3 slides about the interchangeable tool head 1 without experiencing any friction. As such, the user can easily move the tool handle 3 to the distal portions of the interchangeable tool head 1 to apply pressure directly on the outer cutting blade 11. This would cause the outer cutting blade 11 to cleanly cut the malleable material, thereby cleanly separating the high or low relief dimensional element from the rest of the malleable material.

Although the invention has been explained in relation to its preferred embodiment, it is to be understood that many other possible modifications and variations can be made without departing from the spirit and scope of the invention as hereinafter claimed.

What is claimed is:

1. A die cut tool comprises:
an interchangeable tool head;
a magnetic fastening mechanism;
a tool handle;
the interchangeable tool head comprises an outer cutting blade and a sculpting face;
the tool handle comprises a socket portion and a gripping portion;
the socket portion being connected adjacent to the gripping portion;
an opening of the socket portion being oriented away from the gripping portion;
the interchangeable tool head being releasably and slidably attached into the socket portion by the magnetic fastening mechanism;
the sculpting face being oriented away from the magnetic fastening mechanism; and
the outer cutting blade being perimetrically positioned around the sculpting face.

2. The die cut tool as claimed in claim 1 comprises:
the magnetic fastening mechanism comprises a first magnet and a second magnet;
the first magnet being mounted onto the interchangeable tool head, opposite the sculpting face;
the second magnet being integrated into the socket portion; and
the first magnet and the second magnet being magnetically coupled to each other.

3. The die cut tool as claimed in claim 2, wherein the first magnet is configured onto the interchangeable tool head to magnetically attract the second magnet.

4. The die cut tool as claimed in claim 2, wherein the second magnet is configured into the socket portion to magnetically attract the first magnet.

5. The die cut tool as claimed in claim 2 comprises:
the first magnet comprises a first interface area;
the second magnet comprises a second interface area;
the first interface area being offset from the second interface area; and
the first contract area being smaller than the second interface area.

6. The die cut tool as claimed in claim 1 comprises:
at least one stamping protrusion; and
the at least one stamping protrusion being connected onto the sculpting face.

7. The die cut tool as claimed in claim 1 comprises:
at least one stamping recess; and
the at least one stamping recess traversing into the sculpting face.

8. The die cut tool as claimed in claim 1 comprises:
the interchangeable tool head further comprises a protruding shaft;
the protruding shaft traversing into the opening of the socket portion; and
the protruding shaft being slidably mounted within the socket portion.

9. The die cut tool as claimed in claim 8 comprises:
an outer lateral surface of the protruding shaft being encircled by an inner lateral surface of the socket portion; and
the inner lateral surface of the socket portion being annularly offset from the outer lateral surface of the protruding shaft.

10. A die cut tool comprises:
an interchangeable tool head;
a magnetic fastening mechanism;
a tool handle;
the interchangeable tool head comprises an outer cutting blade and a sculpting face;
the tool handle comprises a socket portion and a gripping portion;
the magnetic fastening mechanism comprises a first magnet and a second magnet;
the socket portion being connected adjacent to the gripping portion;
an opening of the socket portion being oriented away from the gripping portion;
the interchangeable tool head being releasably and slidably attached into the socket portion by the magnetic fastening mechanism;
the sculpting face being oriented away from the magnetic fastening mechanism;
the outer cutting blade being perimetrically positioned around the sculpting face;
the first magnet being mounted onto the interchangeable tool head, opposite the sculpting face;
the second magnet being integrated into the socket portion; and
the first magnet and the second magnet being magnetically coupled to each other.

11. The die cut tool as claimed in claim 10, wherein the first magnet is configured onto the interchangeable tool head to magnetically attract the second magnet.

12. The die cut tool as claimed in claim 10, wherein the second magnet is configured into the socket portion to magnetically attract the first magnet.

13. The die cut tool as claimed in claim 10 comprises:
the first magnet comprises a first interface area;
the second magnet comprises a second interface area;
the first interface area being offset from the second interface area; and
the first contract area being smaller than the second interface area.

14. The die cut tool as claimed in claim 10 comprises:
at least one stamping protrusion;
at least one stamping recess;
the at least one stamping recess traversing into the sculpting face; and
the at least one stamping protrusion being connected onto the sculpting face.

15. The die cut tool as claimed in claim 10 comprises:
the interchangeable tool head further comprises a protruding shaft;
the protruding shaft traversing into the opening of the socket portion; and
the protruding shaft being slidably mounted within the socket portion.

16. The die cut tool as claimed in claim 15 comprises:
an outer lateral surface of the protruding shaft being encircled by an inner lateral surface of the socket portion; and
the inner lateral surface of the socket portion being annularly offset from the outer lateral surface of the protruding shaft.

17. A die cut tool comprises:
an interchangeable tool head;
a magnetic fastening mechanism;
a tool handle;
the interchangeable tool head comprises an outer cutting blade and a sculpting face;
the tool handle comprises a socket portion and a gripping portion;
the magnetic fastening mechanism comprises a first magnet and a second magnet;
the socket portion being connected adjacent to the gripping portion;
an opening of the socket portion being oriented away from the gripping portion;
the interchangeable tool head being releasably and slidably attached into the socket portion by the magnetic fastening mechanism;
the sculpting face being oriented away from the magnetic fastening mechanism;
the outer cutting blade being perimetrically positioned around the sculpting face;
the first magnet being mounted onto the interchangeable tool head, opposite the sculpting face;
the second magnet being integrated into the socket portion;
the first magnet and the second magnet being magnetically coupled to each other;
the first magnet is configured onto the interchangeable tool head to magnetically attract the second magnet; and
the second magnet is configured into the socket portion to magnetically attract the first magnet.

18. The die cut tool as claimed in claim 17 comprises:
at least one stamping protrusion;
the first magnet comprises a first interface area;
the second magnet comprises a second interface area;
the first interface area being offset from the second interface area;
the first contract area being smaller than the second interface area;
the at least one stamping protrusion being connected onto the sculpting face;
at least one stamping recess; and
the at least one stamping recess traversing into the sculpting face.

19. The die cut tool as claimed in claim 17 comprises:
the interchangeable tool head further comprises a protruding shaft;
the protruding shaft traversing into the opening of the socket portion; and
the protruding shaft being slidably mounted within the socket portion.

20. The die cut tool as claimed in claim 19 comprises:
an outer lateral surface of the protruding shaft being encircled by an inner lateral surface of the socket portion; and
the inner lateral surface of the socket portion being annularly offset from the outer lateral surface of the protruding shaft.
